(19) United States
(12) Patent Application Publication
(10) Pub. No.: US 2009/0309517 A1
(43) Pub. Date: Dec. 17, 2009

(54) Temperature dependent current control circuit for LED lighting

(76) Inventor: Roberto Debray Chavez Gandara, Juarez (MX)

Correspondence Address: DELPHI TECHNOLOGIES, INC., M/C 480-410-202, PO BOX 5052, TROY, MI, 48007, US

(21) Appl. No.: 12/157,700

(22) Filed: Jun. 12, 2008

(51) Int. Cl. H05B 41/36

(52) U.S. Cl. 315/309

(57) ABSTRACT

An improved LED current control circuit includes a temperature sensor responsive to the ambient temperature for producing a temperature dependent voltage V_{TEMP}, a feedback amplifier responsive to the LED forward current for producing a feedback voltage V_{FB}, a differential amplifier circuit for producing a control signal based on V_{TEMP} and V_{FB}, and a current amplifier for supplying current to the LED based on the control signal. The differential amplifier and current amplifier circuits cooperate to supply LED forward current as required to drive V_{FB} into correspondence with V_{TEMP} so that the LED forward current is also ambient temperature dependent. And the parameters of the feedback amplifier are selected so that the relationship between the LED forward current and the ambient temperature tracks but does not exceed a current de-rating specification for the LED.

### TECHNICAL FIELD

The present invention relates to providing illumination with light emitting diodes (LEDs), and more particularly to a current control circuit for optimizing the LED light output over a range of operating temperatures.

### BACKGROUND OF THE INVENTION

When LEDs are used in automotive instrumentation and other lighting applications, the usual design practice is to set the LED forward current to a value that will achieve acceptable reliability and life under the highest expected temperature conditions. Since applications such as automotive instrumentation can experience temperatures as high as 85° C., the LED current is typically set to a relatively low value such as 7.5 mA, and a relatively large number of LEDs must be used to achieve the required overall illumination level. And this, in turn, can significantly increase the cost of the product. Accordingly, what is needed is a cost effective way of safely and reliably increasing the LED light output in order to reduce the number of LEDs required to satisfy a specified illumination level, and thereby reduce the overall cost of illumination.

### SUMMARY OF THE INVENTION

The present invention is directed to an improved LED current control circuit that automatically regulates the LED forward current based on ambient temperature to enhance the LED illumination level at nominal ambient temperatures while de-rating the forward current at elevated ambient temperatures in accordance with de-rating specifications provided by the LED manufacturer. A temperature sensor responsive to the ambient temperature produces a temperature dependent voltage V_{TEMP}, a feedback amplifier responsive to the LED forward current produces a feedback voltage V_{FB}, a differential amplifier circuit produces a control signal based on V_{TEMP} and V_{FB}, and a current amplifier supplies current to the LED based on the control signal. The differential amplifier and current control circuits cooperate to supply LED forward current as required to drive V_{FB} into correspondence with V_{TEMP} so that the LED forward current is also ambient temperature dependent. And the parameters of the feedback amplifier are selected so that the relationship between the LED forward current and the ambient temperature resembles but does not exceed the LED de-rating specifications.

### BRIEF DESCRIPTION OF THE DRAWINGS

FIG. 1 is a representative current de-rating curve for a LED;

FIG. 2 is a block diagram of an LED current control circuit according to this invention; and

FIG. 3 is a diagram of a circuit for implementing the block diagram of FIG. 2.

### DESCRIPTION OF THE PREFERRED EMBODIMENT

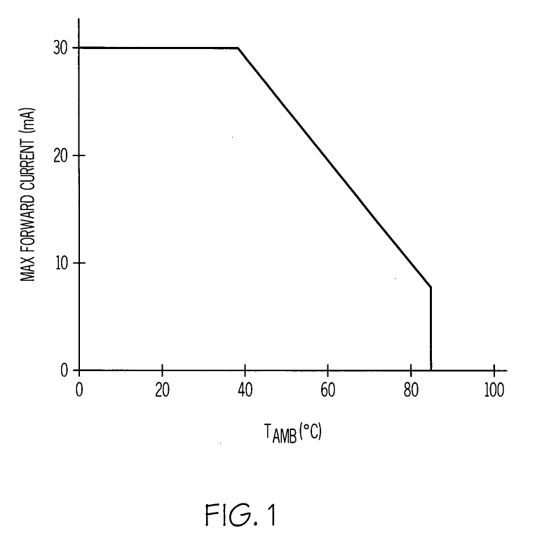

Manufacturers of LEDs specify a maximum forward current value for their LED components, and a de-rating curve that de-rates or reduces the maximum forward current based on the air temperature in the vicinity of the LED (commonly referred as the ambient temperature). A representative de-rating curve is shown in FIG. 1, where the horizontal axis represents the ambient temperature and the vertical axis represents the maximum forward current. In the example of FIG. 1, the maximum forward current is 30 mA when the ambient temperature is 40° C. or less, and progressively de-rates to 7.5 mA at the highest-allowed ambient temperature of 85° C.

A common design practice in driving LEDs is to use the manufacturer's de-rating curve to determine the maximum forward current corresponding to the highest expected ambient temperature, and to set the LED forward current to that value regardless of the actual ambient temperature. In automotive applications where specifications typically require an electronic module to remain functional at temperatures as high as 85° C., this means that the LEDs in the module will ordinarily be driven at a minimal current value such as 7.5 mA. The designer determines the light output of an LED at the selected drive current, and then calculates how many LEDs are needed to achieve the required overall illumination level. In most applications, of course, the actual ambient temperature will be considerably less than 85° C. most of the time, and the required overall illumination level is typically specified for a nominal operating temperature such as 25° C., for which the LEDs may be driven at a higher current to produce more light. It is therefore possible to achieve the required overall illumination level with far fewer LEDs if their forward current is adaptively controlled based on the actual ambient temperature, and the present invention provides a temperature dependent current control circuit based on this principle.

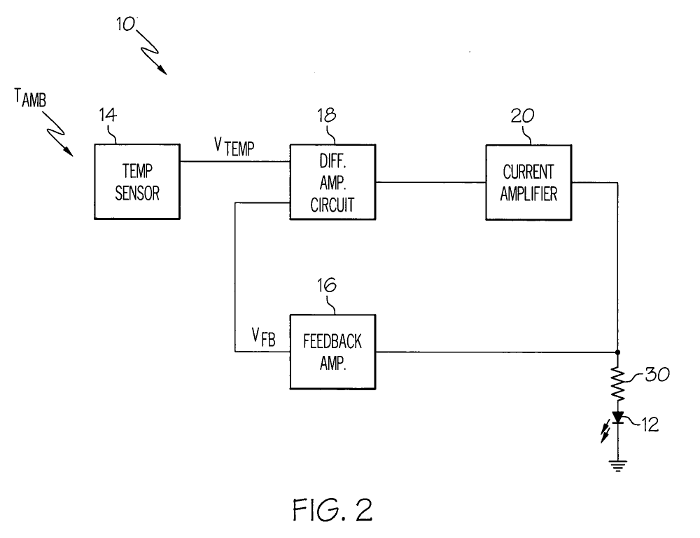

Referring to the block diagram of FIG. 2, the reference numeral 10 generally designates a LED current control circuit according to the present invention, and the reference numeral 12 designates one or more LEDs. If the LEDs 12 are relatively few in number, they may be connected in series; otherwise, they may be connected in a series-parallel arrangement that ensures current sharing. A resistor 30 connected in series with LED 12 limits the LED forward current to a maximum value as explained below. The control circuit 10 includes a temperature sensor 14 responsive to the ambient temperature T_{AMB} for producing a temperature dependent voltage V_{TEMP}, a feedback amplifier 16 responsive to the LED forward current for producing a feedback voltage V_{FB}, a differential amplifier circuit 18 for producing a control signal based on V_{TEMP} and V_{FB}, and a current amplifier 20 for supplying current to LED 12 based on the control signal.

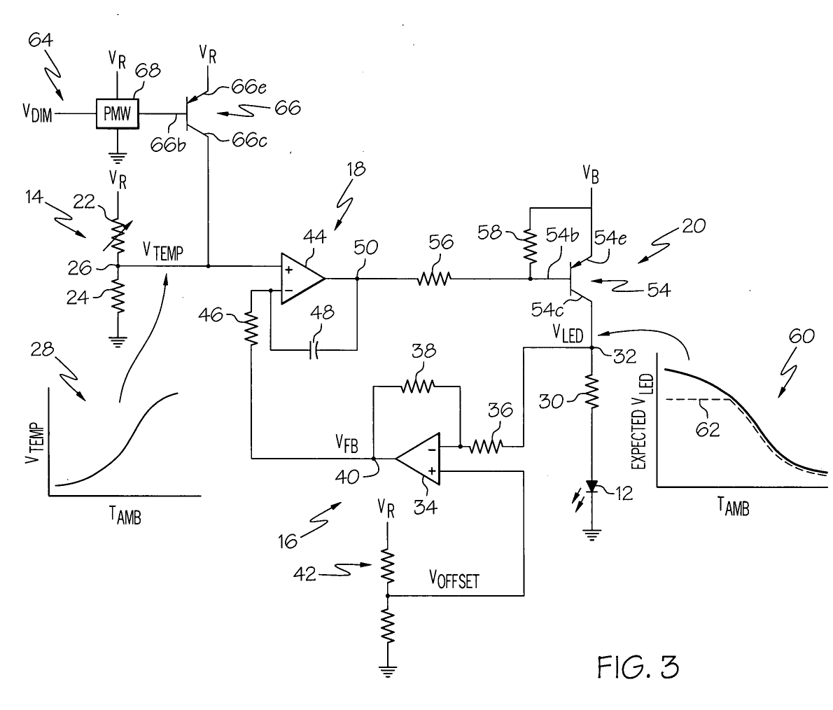

Referring to FIG. 3, the temperature sensor 14 is implemented with a resistive voltage divider supplied by a reference voltage V_{R} such as 5 VDC, including a high-side thermistor 22 and a low-side resistor 24. The resulting temperature dependent voltage V_{TEMP} at the junction 26 between thermistor 22 and resistor 24 is depicted in the graph designated generally by reference numeral 28.

The current amplifier 20 is coupled to supply voltage V_{B}, and supplies current to LED 12 through the current limiting resistor 30. For example, if V_{B} is 14 VDC, resistor 30 may have a value such as 500 ohms in order to limit the LED forward current to approximately 20 mA. The voltage V_{LED} at the junction 32 between current amplifier 20 and resistor 30 is proportional to the LED current, and feedback amplifier 16 includes an operational amplifier 34 responsive to that voltage. The voltage V_{LED} is applied to the inverting input of operational amplifier 34 via series resistor 36, and a feedback resistor 38 is connected between the inverting input of operational amplifier 34 and the output terminal 40 of operational amplifier 34. An offset voltage V_{OFFSET} established by a voltage divider 42 is applied to the non-inverting input of operational amplifier 34. With this configuration, the feedback voltage V_{FB} at the output terminal 40 of operational amplifier 34 may be expressed algebraically as:

V_{FB}=[(−G)V_{LED}]+[V_{OFFSET}(G+1)] (1)

where G is the gain of operational amplifier 34. The gain G, in turn, is determined by the ratio (R₃₈/R₃₆), where R₃₈ is the resistance of feedback resistor 38 and R₃₆ is the resistance of series resistor 36.

Differential amplifier circuit 18 includes a differential amplifier 44 responsive to the temperature dependent voltage V_{TEMP} and the feedback voltage V_{FB}. The feedback voltage V_{FB} is applied to the inverting input of differential amplifier 44 through resistor 46, and a feedback capacitor 48 is connected between the inverting input of differential amplifier 44 and the output terminal 50 of differential amplifier 44.

The current amplifier 20 includes a transistor 54 that supplies current to LED 12 according to the control voltage at the output terminal 50 of differential amplifier 44. The emitter 54e of transistor 54 is coupled to supply voltage V_{B}, the collector 54c is coupled to circuit junction 32, and the base 54b is coupled via resistor 56 to the control voltage at terminal 50. And a pull-up bias resistor 58 couples the base 54b to supply voltage V_{B}.

Differential amplifier circuit 18 and current amplifier 20 cooperate to supply current to LED 12 as required to drive the feedback voltage V_{FB} into correspondence with the temperature dependent voltage V_{TEMP}. For example, if V_{FB} is less than V_{TEMP}, the control voltage at the output terminal 50 of differential amplifier 44 will rise to reduce the current supplied to LED 12, which in turn, will cause V_{FB} to increase toward V_{TEMP}. And if V_{FB} is greater than V_{TEMP}, the control voltage at the output terminal 50 of differential amplifier 44 will fall to increase the current supplied to LED 12, which in turn, will cause V_{FB} to decrease toward V_{TEMP}. As a result, it can be expected that the voltage V_{LED} at circuit junction 32 (and hence, the LED current) will vary with ambient temperature T_{AMB} as does V_{TEMP}. However, since operational amplifier 34 is configured to provide negative gain, the V_{LED} vs. T_{AMB} curve will be inverted with respect to the V_{TEMP} vs. T_{AMB} curve 28, as depicted by the solid trace in the graph generally designated by the reference numeral 60. This may also be shown mathematically by solving equation (1) for V_{LED} and substituting V_{TEMP} for V_{FB}. This yields:

V_{LED}[(−K)V_{TEMP}]+[V_{OFFSET}(K+1)] (2)

where K=1/G.

The gain G of operational amplifier 34 determines the slope of the expected V_{LED} vs. T_{AMB} curve, and the offset voltage V_{OFFSET} determines its voltage offset. Advantageously, the shape of the V_{LED} vs. T_{AMB} curve can be further manipulated by configuring operational amplifier 34 so that it saturates to limit V_{LED} to a maximum value as designated by the broken trace 62 in graph 60. This can be achieved, for example, by suitably selecting the supply voltage for operational amplifier 34. The objective in selecting the gain G, the offset voltage V_{OFFSET}, and the operational amplifier saturation voltage is to make the V_{LED} vs. T_{AMB} curve closely track, but not exceed, the de-rating curve for the LED 12. In this way, the current supplied to LED 12 will automatically vary with the sensed ambient temperature T_{AMB}, but not exceed the de-rating curve supplied by the LED manufacturer.

Finally, dimming of the LED illumination is achieved with a dimming circuit 64 that modulates the temperature dependent voltage V_{TEMP} with the reference voltage V_{R} used to create V_{TEMP}. In the embodiment of FIG. 3, the dimming circuit 64 includes a transistor 66 having a emitter 66e connected to V_{R}, a collector 66c connected to circuit terminal 26, and a base 66e connected to a PWM circuit 68. The PWM circuit 68 is controlled by a dimming voltage V_{DIM}, and modulates transistor 66 on and off at a variable duty controlled by V_{DIM} when dimming is requested. This effectively increases V_{TEMP} to produce a corresponding reduction in the forward current of LED 12.

In summary, the present invention provides a current control circuit for LED lighting that automatically regulates the LED forward current based on ambient temperature to enhance the LED illumination level at nominal ambient temperatures while de-rating the forward current at elevated ambient temperatures in accordance with de-rating specifications provided by the LED manufacturer. This significantly reduces the number of LEDs required to achieve a specified illumination level at nominal ambient temperatures, providing a cost savings that substantially exceeds the cost of the current control circuit components.

While the present invention has been described with respect to the illustrated embodiment, it is recognized that numerous modifications and variations in addition to those mentioned herein will occur to those skilled in the art. Accordingly, it is intended that the invention not be limited to the disclosed embodiment, but that it have the full scope permitted by the language of the following claims.

1. A temperature dependent current control circuit for one or more light emitting diodes (LEDs), comprising:
a temperature sensor responsive to an ambient temperature for producing an ambient temperature dependent voltage V_{TEMP};
a feedback amplifier responsive to a forward current of the LEDs for producing a feedback voltage V_{FB};
a differential amplifier circuit for producing a control signal based on V_{TEMP} and V_{FB}; and
a current amplifier circuit for supplying current to the LEDs based on the control signal;
where the differential amplifier and current amplifier circuits cooperate to supply forward current to the LEDs as required to drive V_{FB} into correspondence with V_{TEMP} so that the forward current of the LEDs is also ambient temperature dependent.

2. The temperature dependent current control circuit of claim 1, where:
one or more parameters of the feedback amplifier are selected so that a relationship between the forward current of the LEDs and the ambient temperature tracks but does not exceed a current de-rating specification for the LEDs.

3. The temperature dependent current control circuit of claim 2, where:
the parameters of the feedback amplifier include a gain and an offset voltage.

4. The temperature dependent current control circuit of claim 2, where:
the parameters of the feedback amplifier include a gain, an offset voltage, and a saturation voltage.

5. The temperature dependent current control circuit of claim 1, further comprising:
a dimming circuit for controllably increasing V_{TEMP} to produce corresponding reductions in the forward current of the LEDs and a light emitted by the LEDs.

6. The temperature dependent current control circuit of claim 5, where:
the dimming circuit includes a switching element that modulates V_{TEMP} with a reference voltage to controllably increase V_{TEMP}.
